(19) United States
(12) Patent Application Publication
(10) Pub. No.: US 2012/0304052 A1
(43) Pub. Date: Nov. 29, 2012

(54) Systems And Methods For Displaying An Image In A Plurality Of Designs

(76) Inventors: Wesley Tanaka, Honolulu, HI (US); Mariam Naficy, San Francisco, CA (US)

(21) Appl. No.: 13/117,932

(22) Filed: May 27, 2011

(51) Int. Cl. G06F 17/00

(52) U.S. Cl. 715/243

(57) ABSTRACT

Systems and methods are provided for generating a graphical design having one or more embedded images for purchase over a computer network. An system may include a processing system, a template database, and an image processing application stored in a memory device and executable by the processing system. The application may be configured to: receive one or more digital images over the computer network for inclusion in the graphical design; receive input to select a design category; receive, based on the selected design category, a set of graphical templates from the plurality of graphical templates stored in the template database; embed the one or more digital images in each graphical template in the set of graphical templates to generate a plurality of candidate graphical designs; display the plurality of candidate graphical designs simultaneously on a user interface; and receive a selection of one of the plurality of candidate graphical designs.

### FIELD

The technology described in this patent document relates generally to computer-based image and graphic processing, such as on-line photo processing systems.

### BACKGROUND

Traditional providers of graphic design products (e.g., greeting cards, business cards, flyers, brochures) offer a limited number of designs generated by in-house creators or paid third party contractors. Limited customizations may be available for these design products, such as the incorporation of a corporate logo onto business cards or the inclusion of a photograph onto a greeting card. While the designs provided may be appropriate for many applications and occasions, the limited number of parties having creative input may result in a too-rigid environment that does not offer sufficient options for conveying certain messages.

Thus, there is a need for a graphics design system that offers consumers the capability to create and/or customize graphic designs according to their communications needs. There is also a need for a system where those consumer-created designs can be shared among the population of consumers, thus increasing the creative talent pool for graphic design.

### SUMMARY

In accordance with the teachings described herein, systems and methods are provided for generating a graphical design having one or more embedded images for purchase over a computer network. An example system may include a processing system, a template database for storing a plurality of graphical templates, and an image processing application stored in a memory device and executable by the processing system. When executed, the image processing application may be configured to: receive one or more digital images over the computer network for inclusion in the graphical design; receive input to select a design category; receive, based on the selected design category, a set of graphical templates from the plurality of graphical templates stored in the template database; embed the one or more digital images in each graphical template in the set of graphical templates to generate a plurality of candidate graphical designs; display the plurality of candidate graphical designs simultaneously on a user interface; and receive input to select one of the plurality of candidate graphical designs.

An example computer-implemented method for generating a graphical design having one or more embedded images for purchase over a computer network may include: receiving one or more digital images over the computer network for inclusion in the graphical design; receiving input to select a design category; receiving a set of graphical templates from a plurality of stored graphical templates based on the selected design category; embedding the one or more digital images in each graphical template in the set of graphical templates to generate a plurality of candidate graphical designs; displaying the plurality of candidate graphical designs simultaneously on a user interface; and receiving input to select one of the plurality of candidate graphical designs.

### BRIEF DESCRIPTION OF THE DRAWINGS

FIG. 1 is a block diagram of an example system for generating and displaying multiple graphical designs that include common image data.

FIG. 2 depicts an example of a user interface for displaying a plurality of graphical designs with an embedded image.

FIG. 3 is a block diagram of another example system for generating and displaying multiple graphical designs that include common image data.

FIG. 4 is an example of a user interface that may be provided for uploading one or more images.

FIG. 5 is a flow diagram of an example method for generating and displaying multiple graphical designs that include common image data.

FIG. 6 depicts an example client server architecture that may be used for implementing the systems and method described herein.

### DETAILED DESCRIPTION

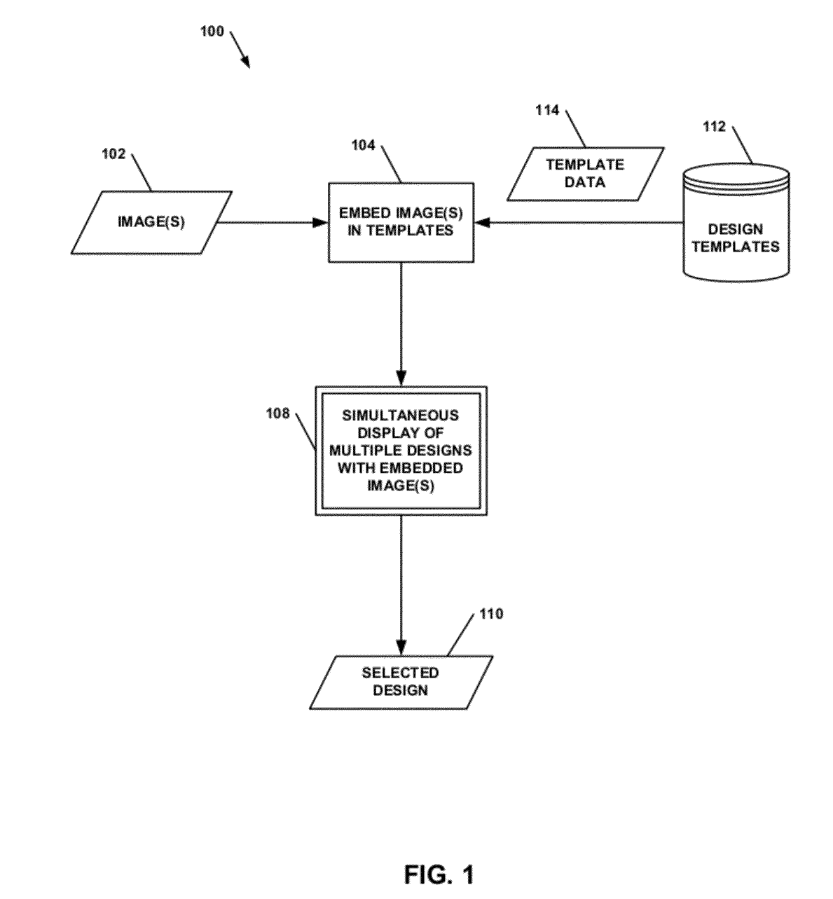

FIG. 1 is a block diagram of an example system 100 for generating and displaying multiple graphical designs that include common image data 102. The image data 102 may, for example, include one or more digital photographs or other images provided by a user. For instance, in one example, the image data 102 may include one or more digital photographs or graphical icons that are uploaded to the system 100 over a computer network, such as the Internet. In system block 104, the image data 102 is embedded into multiple design templates such that the same image(s) is included in each of a plurality of different graphical designs. The plurality of graphical designs, each having the same embedded image(s), is then displayed at system block 108 to enable a user to simultaneously review the designs and select one or more particular designs 110 for further processing.

As illustrated in FIG. 1, the plurality of designs may be generated using stored templates 112 that include one or more slots for embedding image data. In one example, a set of template data 114 may be selected from a template database 112, either by a user or automatically by the system 100, for use with the received image data 102. For instance, a user may select a desired set of graphical templates from the database 112 via a user interface. In another example, the system 100 may choose template data 114 automatically or based on some other user input. For example, a user may select a category of templates, and the system 100 may then automatically select a plurality of templates 114 from the database 112 that belong to the selected category.

As an example, if a user uploads a digital photograph 102 to the system 100 and selects a Holiday card category, then the system 100 may automatically select a plurality of Holiday card templates and embed the photograph 102 within each template to generate a plurality of Holiday card designs for simultaneous display 108. In another example, a user may upload an image 102 of a business logo to the system 100 and select a business card category. The system 100 may then automatically select a plurality of business card templates 114, and embed the business logo into the templates to generate a plurality of business card designs for simultaneous display 108.

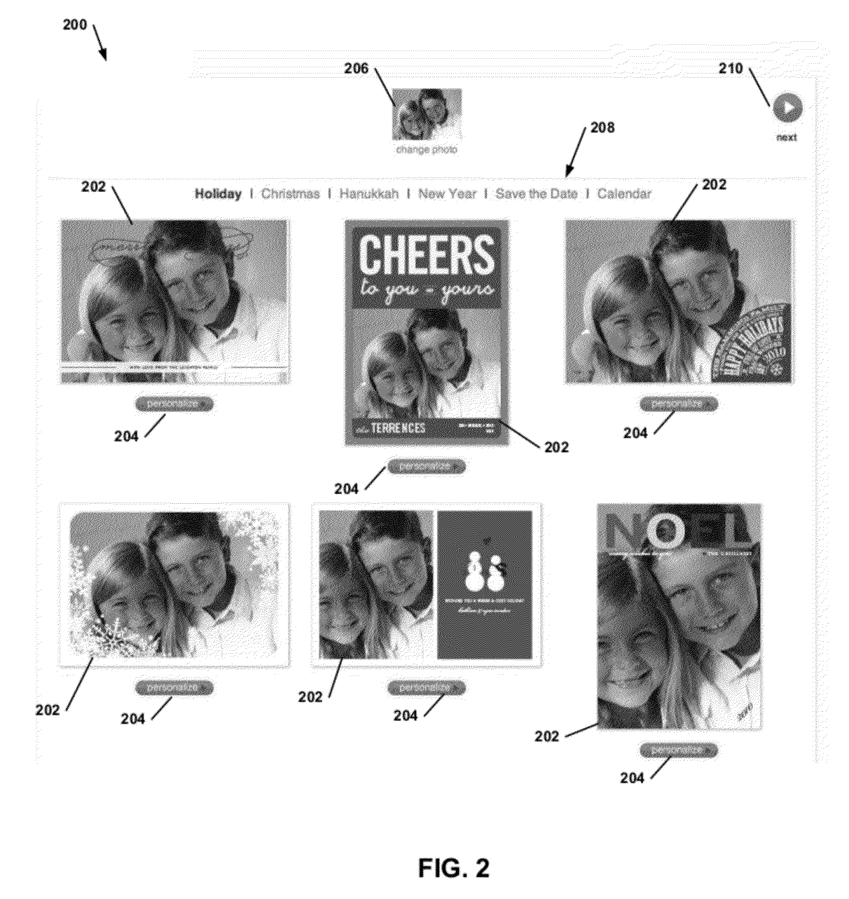

In one example, the plurality of graphical designs may be displayed, with the embedded image(s), on a user interface to enable a user to select a graphical design 110 for further processing. For instance, upon selecting one of the displayed designs, the user may be able to perform one or more image processing operations on the graphical design (e.g., cropping, color adjustment, cropping, zooming, etc.), personalize the design (e.g., by adding text, changing the color configuration, etc.) and/or add the design to a virtual shopping cart for purchase. An example of a user interface 200 for displaying a plurality of graphical designs with an embedded image(s) is illustrated in FIG. 2.

The example user interface 200 illustrated in FIG. 2 may, for example, be displayed to a client computer over a computer network from an image processing system, such as the one described above with reference to FIG. 1. The user interface 200 displays a plurality of graphical designs 202, each having the same embedded image(s), so that the user may simultaneously view the designs in a side-by-side fashion on the same screen. As shown, the user interface 200 may include selection fields 204, such as graphical buttons, for selecting a particular one of the designs for further processing and/or for purchase. The user interface 200 may also include an input field 206 that causes the system to change the embedded image(s). For instance, upon selecting the input field 206, the system may provide another interface to enable the user to upload a different image(s) or to choose from one or more previously uploaded images, and then replace the embedded image(s) in the currently displayed designs 202 with the newly selected image(s).

Also illustrated in the example user interface 200 of FIG. 2 are a plurality of design category selection fields 208. As shown, these fields 208 may be used to identify the currently-selected design template category and also to enable the user to select a different category. For instance, in the illustrated example the “Holiday” field is highlighted to indicate that the currently-displayed designs 202 are generated using a set of “Holiday” templates. In addition, other category fields 208 are displayed, but not highlighted, to enable the user to switch the current set of templates with another set. For instance, if the user were to select the “New Year” field in the interface 200, then the system may cause the image(s) to be embedded into a set of “New Year” design templates and then replace the designs 202 currently displayed on the interface 200 with a plurality of simultaneously displayed “New Year” designs. Other example template categories may include templates for invitations, stationery cards, calendars, book covers, business cards, wall hangings, website templates, social media profile pages, or other formats.

The example user interface 200 shown in FIG. 2 also includes an input field 210 that causes the system to display a next set of designs. For instance, if the user selects a particular category of template (e.g., Holiday cards) in which to embed the image(s), the interface 200 may first display a set of designs 202 created using a subset of the available templates in that category. The initial subset may, for example, be selected by ranking the templates in each category according to some predetermined criteria, such as their popularity (e.g., based on how often the template is included in a purchased design), price, a user-entered search term, or some other criteria. When the “next” input field 210 is selected, the system may then select a new template subset in the category (e.g., the next most highly ranked set), and embed the same image(s) within the new set of templates for simultaneous display on the interface 200. In another example, the user interface 200 may also include a “previous” input field that enables a user to return to a previously displayed subset of templates.

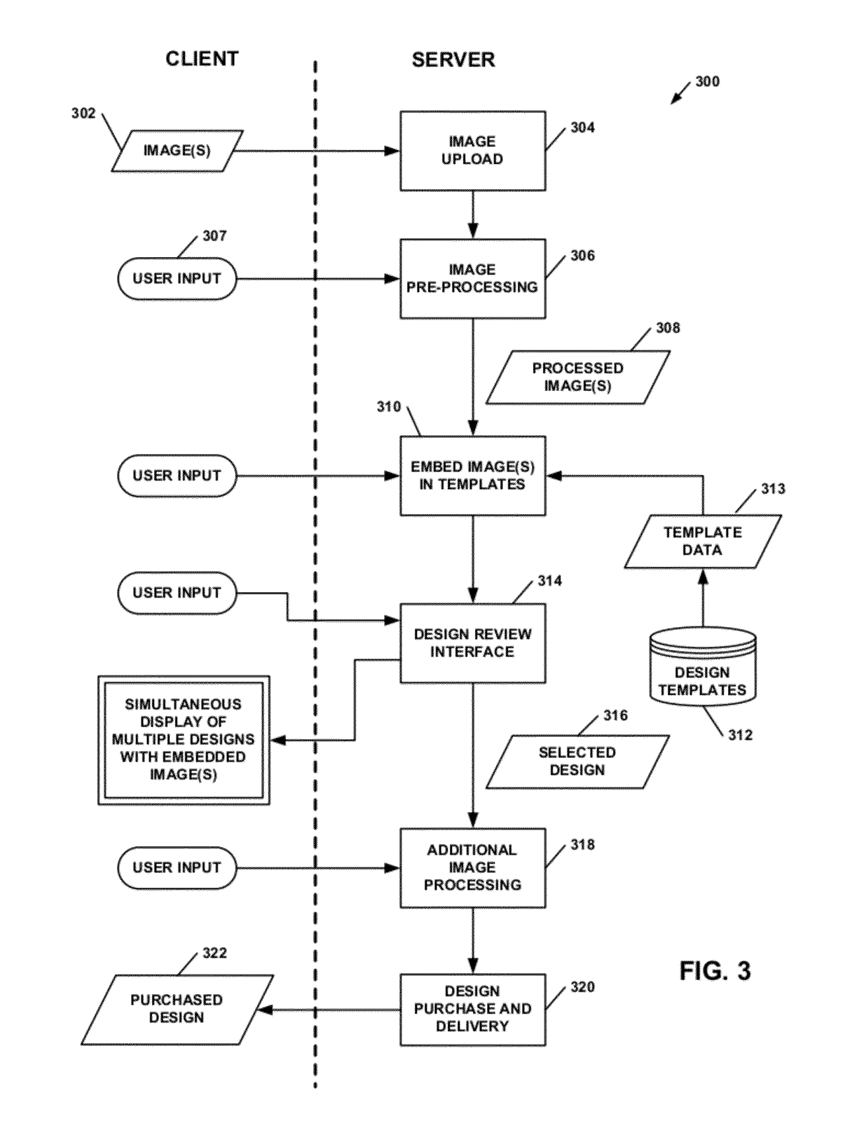

FIG. 3 is a block diagram of another example system 300 for generating and displaying multiple graphical designs that include common image data 302. The system 300 shown in FIG. 3 includes a dotted line to distinguish processes that may be implemented by one or more client-side device from processes that may be implemented by one or more server-side devices in a network environment. It should be understood, however, that in other embodiments one or more of the client-side operations may instead be performed on a server-side device(s), and vice versa. It should also be understood that each of the system blocks illustrated in FIGS. 1 and 3, and described herein, may be implemented by software instructions executing on one or more processing devices. In other implementations, however, one or more operations of these system blocks may instead be performed by other known mechanisms such as firmware or even appropriately designed hardware. In addition, the design template database shown in FIGS. 1 and 3, and described herein, may be implemented using one or more memory devices, either on the server or separate from the server.

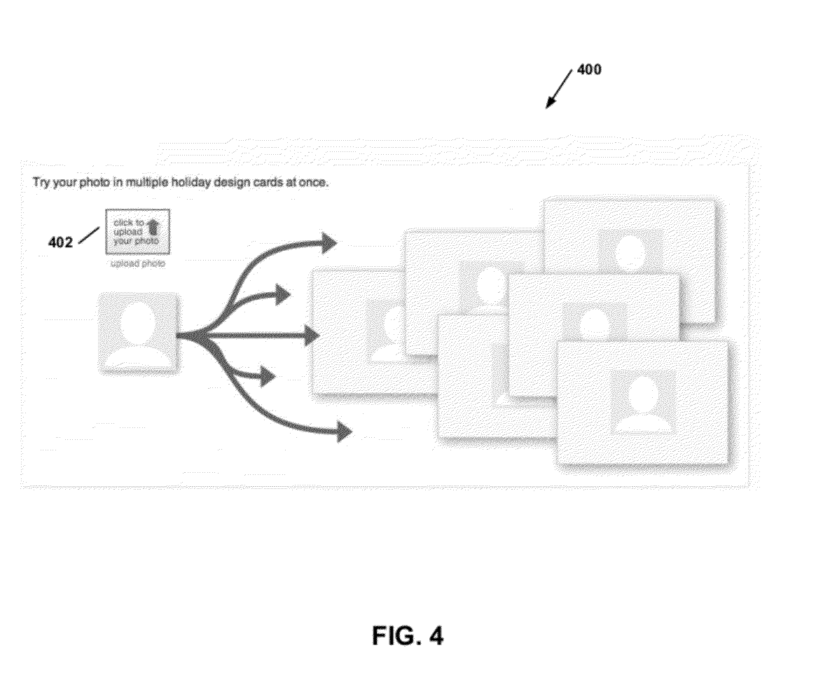

With reference to FIG. 3, the server may provide an image upload user interface 304 that enables the image(s) 302 to be uploaded from a client device. An example of a user interface 400 that may be provided for uploading one or more images is illustrated in FIG. 4. As shown in FIG. 4, the image upload interface 400 may include an input field 402 that provides the user with a mechanism (e.g., a pop-up window) for selecting one or more image files for upload from the client device.

With reference again to FIG. 3, the uploaded image(s) may then be processed by an image pre-processing block 306, such as a photo editing software application. The image pre-processing block 306 may, for example, be used to provide color adjustment, red-eye correction, transformation into sepia or black-and-white, cropping, zooming, translation, rotation, aspect ratio adjustment, and/or other image processing operations. User input 307 may be received from the client to the image pre-processing block 306, for example to provide certain image processing settings or otherwise control one or more of the image processing operations. It should be understood, however, that in other embodiments one or more (or perhaps all) of the image pre-processing operations 306 may be performed automatically by the server without user input 308. For instance, in one embodiment the image pre-processing block 306 may automatically provide red-eye correction and/or other adjustments to each uploaded image 302.

The processed image 308 is then embedded into multiple design templates by system block 310, such that the same image(s) is included in each of a plurality of different graphical designs. The plurality of designs may be generated using stored templates 312 that include one or more slots for embedding image data. For instance, a set of template data 313 may be selected from a template database 312, as described above with reference to FIGS. 1 and 2.

The plurality of graphical designs, each with the same embedded image(s), is displayed by system block 314 to enable a user to simultaneously review the designs and select one or more particular designs for further processing. For instance, system block 314 may provide a user interface, such as the one shown in FIG. 2, that enables the plurality of graphical designs to be simultaneously viewed from the client device and that enables the user to select a particular design 316 for further processing.

The selected design(s) 316 may then be passed to block 318 for further image processing. For instance, the design 316 may be customized by adding or modify text, modifying the color scheme, moving design elements around on the design, adding backs, interiors or accessories to the design, or otherwise modifying the appearance of the design. In addition, one or more of the image processing functions from pre-processing block 306 may again be provided at block 318 to enable further image processing operations, such as color adjustment, red-eye correction, cropping, etc. The final design(s) may then be purchased and delivered to the client by system block 320. For instance, system block 320 may include a virtual shopping cart application that enables a user at the client to securely provide payment and delivery information to the server. A virtual shopping cart application 320 may, for example, verify the user's purchase information, authorize the purchase (e.g., by contacting an identified financial institution) and provide the purchased design 322 for download, printing or other means of delivery to the client.

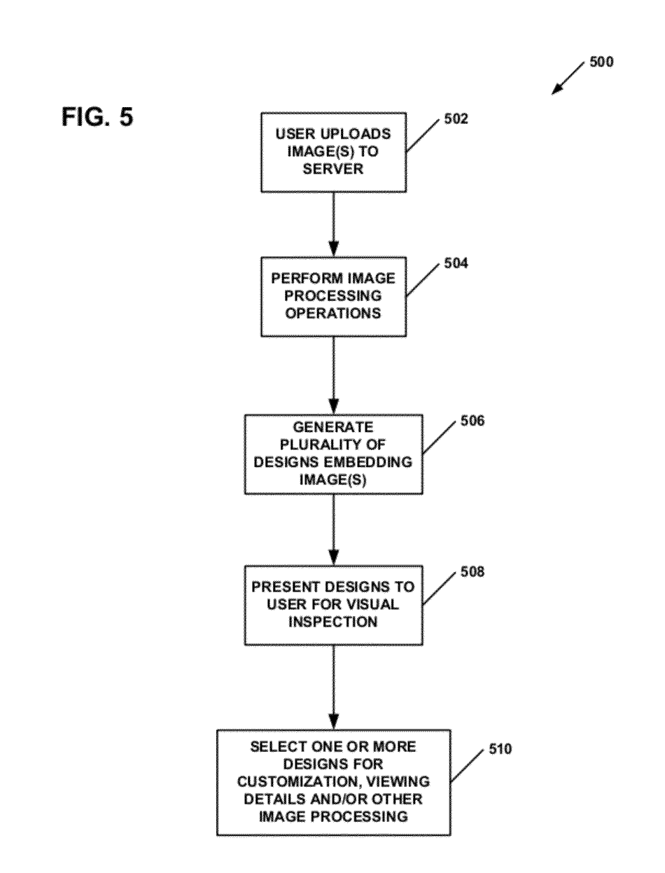

FIG. 5 is a flow diagram of an example method 500 for generating and displaying multiple graphical designs that include common image data. At 502, one or more digital images are uploaded to a server from a client device. One or more image processing operations are then performed at 504. For instance, the uploaded image may be processed, with or without user input, to provide color adjustment, red-eye correction, transformation into sepia or black-and-white, cropping, rotation, aspect ratio adjustment, and/or other image processing operations.

A plurality of graphical designs are generated at 506 by embedding the uploaded image(s) into one or more predefined slots in a set of design templates, such that each of the plurality of graphical designs includes the same image(s) within different design templates. The plurality of graphical designs are then displayed simultaneously at 508, such that the user may visually inspect all of the plurality of graphical designs at the same time. One or more of the displayed graphical designs is then selected by a user at 510 for customization, viewing details and/or other image processing.

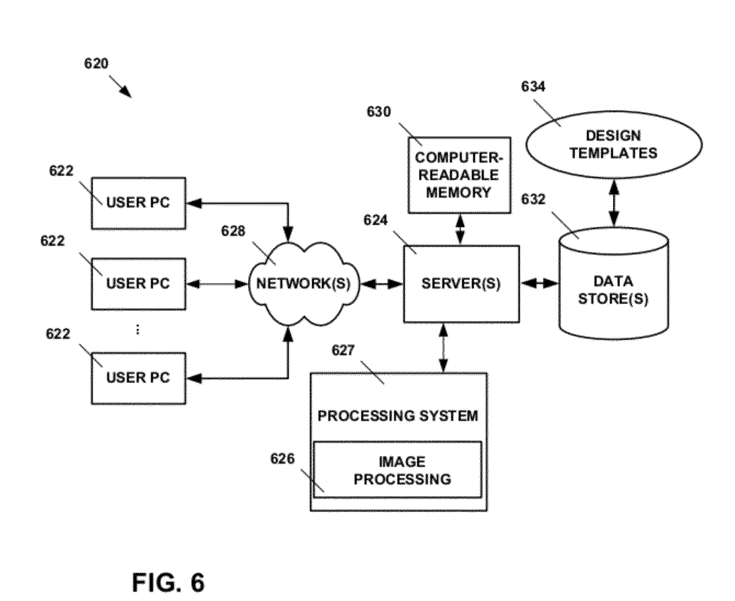

FIG. 6 depicts an example client server architecture 620 that may be used for implementing the systems and method described herein. One or more user PCs 622 access one or more servers 624 running an image processing application 626 on a processing system 627 via one or more networks 628. The one or more servers 624 may access a computer readable memory 630 as well as one or more data stores 632, for instance to access design template data 634.

This written description uses examples to disclose the invention, including the best mode, and also to enable a person skilled in the art to make and use the invention. The patentable scope of the invention may include other examples that occur to those skilled in the art.

It is further noted that the systems and methods described herein may be implemented on various types of computer architectures, such as for example on a single general purpose computer or workstation, or on a networked system, or in a client-server configuration, or in an application service provider configuration.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It is claimed:

1. A computer-implemented method for generating a graphical design having one or more embedded images for purchase over a computer network, comprising:
receiving one or more digital images over the computer network for inclusion in the graphical design;
receiving input to select a design category;
receiving a set of graphical templates from a plurality of stored graphical templates based on the selected design category;
embedding the one or more digital images in each graphical template in the set of graphical templates to generate a plurality of candidate graphical designs;
displaying the plurality of candidate graphical designs simultaneously on a user interface; and
receiving input to select one of the plurality of candidate graphical designs.

2. The method of claim 1, wherein the plurality of stored graphical templates includes a plurality of graphical templates that are categorized within the selected design category, and wherein the received set of graphical templates is a subset selected from the plurality of graphical templates within the selected design category.

3. The method of claim 2, wherein the subset is automatically selected based on a predefined ranking of the plurality of graphical templates within the selected design category.

4. The method of claim 3, wherein the predefined ranking is based on popularity of the plurality of graphical templates within the selected design category, wherein popularity is determined based on sales data.

5. The method of claim 3, wherein the predefined ranking is based on at least one of price and a received search term.

6. The method of claim 1, further comprising:
providing the selected one of the plurality of candidate graphical designs for at least one of download over the computer network and printing.

7. The method of claim 1, further comprising:
customizing the selected graphical design based on user input received over the computer network.

8. The method of claim 7, wherein the customization comprises adding text to the selected one of the plurality of candidate graphical designs.

9. The method of claim 7, further comprising:
providing the customized graphical design for download over the computer network.

10. The method of claim 1, further comprising:
performing one or more image processing operations to modify the received one or more digital images.

11. The method of claim 1, wherein more than one of the plurality of candidate graphical designs are selected.

12. A system for generating a graphical design having one or more embedded images for purchase over a computer network, comprising:
a processing system;
a template database for storing a plurality of graphical templates; and
an image processing application stored in a memory device and executable by the processing system, when executed the image processing application being configured to:
receive one or more digital images over the computer network for inclusion in the graphical design;
receive input to select a design category;
receive, based on the selected design category, a set of graphical templates from the plurality of graphical templates stored in the template database;
embed the one or more digital images in each graphical template in the set of graphical templates to generate a plurality of candidate graphical designs;
display the plurality of candidate graphical designs simultaneously on a user interface; and
receive input to select one of the plurality of candidate graphical designs.

13. The system of claim 12, wherein the plurality of stored graphical templates includes a plurality of graphical templates that are categorized within the selected design category, and wherein the received set of graphical templates is a subset selected from the plurality of graphical templates within the selected design category.

14. The system of claim 13, wherein the subset is automatically selected based on a predefined ranking of the plurality of graphical templates within the selected design category.

15. The system of claim 14, wherein the predefined ranking is based on popularity of the plurality of graphical templates within the selected design category, wherein popularity is determined based on sales data.

16. The system of claim 12, wherein the image processing application is further configured to:
provide the selected one of the plurality of candidate graphical designs for download over the computer network.

17. The system of claim 12, wherein the image processing application is further configured to customize the selected graphical design based on user input received over the computer network.

18. The system of claim 17, wherein the customization comprises adding text to the selected one of the plurality of candidate graphical designs.

19. The system of claim 17, wherein the image processing application is further configured to provide the customized graphical design for download over the computer network.

20. The system of claim 12, wherein the image processing application is further configured to perform one or more image processing operations to modify the received one or more digital images.

21. The system of claim 12, wherein more than one of the plurality of candidate graphical designs are selected.
